(19) United States
(12) Patent Application Publication
(10) Pub. No.: US 2009/0175546 A1
(43) Pub. Date: Jul. 9, 2009

(54) Method and Apparatus for Dynamic Compression in Images or Signal Series

(75) Inventors: Willi Platz, Muenchen (DE); Gerald Sobotta, Sauerlach (DE); Dieter Wolf, Amerang (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottobrunn (DE)

(21) Appl. No.: 12/281,876

(22) PCT Filed: Mar. 7, 2007
(86) PCT No.: PCT/DE2007/000414

§ 371 Date: Jan. 21, 2009

(30) Foreign Application Priority Data
Mar. 8, 2006 (DE) 10 2006 011 066.8

(51) Int. Cl. G06K 9/36

(52) U.S. Cl. 382/232

(57) ABSTRACT

In a method and apparatus for dynamics compression in images or signal series represented by individual amplitude values, input amplitude values EA of the images or signal series are subjected to a local spatial amplitude averaging, to generate locally spatially averaged input amplitude values <EA>. Differential function values are then formed based on differences between the input amplitude values EA and the locally spatially averaged input amplitude values <EA>, and output amplitude values AA of the images or signal series are generated from the formed differential function values. In forming the differential function, additional differential values are superimposed on the differences formed from the input amplitude values EA and the locally spatially averaged input amplitude values <EA>, which additional differential values are formed from the input amplitude values EA and a predefined reference value GA.

This application is a national stage of International Application No. PCT/DE2007/000414, filed Mar. 7, 2007, which claims priority under 35 U.S.C. §119 to German Patent Application No. 10 2006 011 066, filed Mar. 8, 2006, the entire disclosure of which is herein expressly incorporated by reference.

The invention relates to a method and apparatus for dynamics compression in images or signal series that are represented by a plurality of amplitude values.

When analyzing images or signal series which are obtained, for example, by video monitoring (gray video, color video, IR video), night vision devices or other recordings, under poor illumination conditions, the brightness variations contained in the image can often be detected by the human eye only to a small extent. Therefore a large part of the information existing in the image despite the poor illumination conditions, is not accessible to the viewer.

Image processing methods are known by which input amplitude values of the images or signal series are subject to a local spatial amplitude averaging and the differences between the input amplitude values and the locally spatially averaged input amplitude values are formed. By applying a sigmoid function, output amplitude values of the images or signal series are generated from these differences, which output amplitude values are characterized by an intensification of edges contained in the image, while, however, in homogeneous image areas, all pixels (picture elements) are set to median gray. This method is known as the Mead-Mahowald Retina Function and is described in Mead, Carver A. and Mahowald, M. A., Neural Network 1, Page 91, (1988) or in Mahowald, M. and Mead C. A., (1991, May) Silicon Retina, Sci. Amer.: 76-72. This method, however, engenders an almost complete loss of brightness differences contained in the image, and it cannot be applied to color images because the brightnesses in the individual color channels are adulterated such that the colors themselves are thereby also adulterated.

One object of the invention is to provide a process and system for dynamics compression of images or signal series, by which the brightness variations become recognizable, while the contrasts present in the image are maintained.

This and other objects and advantages are achieved by the process according to the invention, in which input amplitude values EA of the images or signal series are subjected to a local spatial amplitude averaging to generate locally spatially averaged input amplitude values <EA>. Based on differences between the input amplitude values EA and the locally spatially averaged input amplitude values <EA>differential function values are formed, and output amplitude values AA of the images or signal series are generated from the differential function values. According to the invention, in forming the differential function values, additional differential values are superimposed on the differences formed from the input amplitude values EA and the locally spatially averaged input amplitude values <EA>. The additional differential values are formed from the input amplitude values EA and a predefined reference value GA.

According to an advantageous embodiment of the process according to the invention, the output amplitude values AA of the images or signal series are generated by applying a sigmoid function to the formed differential function values.

According to an advantageous embodiment of the process according to the invention, the differential value formation has the form of

(EA-<EA>)+b.(EA-GA),

wherein b is a predefined weighting factor.

According to an advantageous embodiment of the process according to the invention, the local spatial amplitude averaging takes place over an averaging area or range, with weights decreasing from the center of the area or range. The area or range may be square, circular, rectangular or elliptical.

In one embodiment of the method according to the invention, the reference value GA has a constant value. However, it may also be set to half the maximal amplitude of the input amplitude values EA.

According to an advantageous embodiment of the process according to the invention, non-color images are processed, while in another advantageous embodiment of the process according to the invention, color images are processed, with differential function values being formed for each color channel.

According to an advantageous embodiment of the process according to the invention, the differential function values are formed vectorially, with vectorial averaging of the input amplitude values EA being performed according to the expression <EA>=(<EAR>+<EAG>+<EAB>)/3.

The process can be carried out either in an analog mode, or digitially.

The invention also provides a system for dynamics compression in images or signal series which are represented by individual amplitude values. The system includes apparatus for subjecting input amplitude values EA of the images or signal series to a local spatial amplitude averaging to generate locally spatially averaged input amplitude values <EA>; for forming differential function values based differences between the input amplitude values EA and the locally spatially averaged input amplitude values <EA>; and for generating output amplitude values AA of the images or signal series from the formed differential function values. According to the invention, in forming the differential function values, the system superimposes additional differential values on the differences between the input amplitude values EA and the locally spatially averaged input amplitude values <EA>. The additional differential values are formed from the input amplitude values EA and a predefined reference value GA.

According to an advantageous embodiment of the invention, the system generates the output amplitude values AA of the images or signal series by applying a sigmoid function to the formed differential function values.

According to an advantageous embodiment of the invention, the system implements the differential value formation according to the expression (EA-<EA>)+b.(EA-GA), wherein b is a predefined weighting factor.

According to an advantageous embodiment of the invention, the system implements the local spatial amplitude averaging over an averaging area or range with weights that decrease from the center of the area or range. The area or range may be square, circular, rectangular or elliptical.

The reference value GA may have a constant value, or alternatively it can be set to half the maximal amplitude of the input amplitude values EA.

According to an advantageous embodiment of the invention, the system processes non-color images, while in another advantageous embodiment of the invention, processing is performed on color images, with differential function values being formed separately for each color channel.

According to an advantageous embodiment of the invention, the system forms the differential function values by a vectorial averaging of the input amplitude values EA, according to the expression <EA>=(<EAR>+<EAG>+<EAB>)/3.

The system according to the invention can operate either in an analog mode, or digitally.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of the method and the system for the dynamics compression of images or signal series according to an embodiment of the invention;

FIG. 2 is a diagram of amplitude processing according to the known Mead-Mahowald retina function (MMR);

FIG. 3 is a diagram of a comparison between the transformation of the amplitude difference using the known Mead-Mahowald retina function (MMR) and the dynamics compression (adaptive dynamics compression) according to an embodiment of the invention;

FIG. 4 is a diagram of amplitude processing in dynamics compression of images or signal series according to an embodiment of the invention; and

FIG. 5 is a diagram of a comparison between the amplitude processing using the known Mead-Mahowald retina function (MMR) and dynamics compression (adaptive dynamics compression) according to the embodiment of the invention.

### DETAILED DESCRIPTION OF THE DRAWINGS

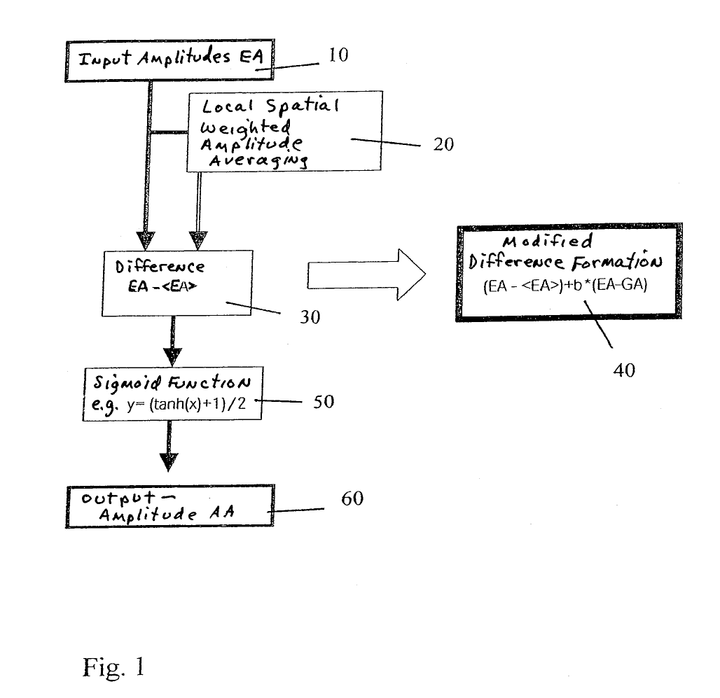

According to FIG. 1, amplitude values EA of the images or signal series, which are to be subjected to a dynamics compression, are input in an input block 10. These input amplitude values EA are subjected to a local spatial amplitude averaging 20, thereby forming averaged input amplitude values <EA>. The input amplitude values EA and the locally spatially averaged input amplitude values <EA> are subjected to a difference formation 30 where their difference EA-<EA> is analyzed. In the present embodiment of the invention, this difference formation 30 is subjected to a modified difference formation 40, in the form of

(EA-<EA>)+b.(EA-GA),

in which GA is a predefined reference value and b is a predefined weighting factor. After this modified difference formation 30, 40, the result is subjected to a sigmoid function 50, which may, for example, have the form of

y=(tanh(x)+1)/2.

The sigmoid function generally has an S-shaped trace between an upper limit value and a lower limit value, which approximates asymptotically it in each case. It causes a compression of the modified differential values formed at reference number 40 to output amplitude values AA which are emitted at reference number 60.

A system for dynamics compression in the described manner is correspondingly constructed, such that it subjects the input amplitude values of the images or signal series to be processed (obtained at reference number 10) to a local spatially weighted amplitude averaging. From differences between the input amplitude values EA and the locally spatially averaged input amplitude values <EA>30, it forms a modified difference of the indicated form (EA-<EA>)+b.(EA-GA) 40. The difference formed in such a modified manner is subjected at reference number 50 to the described sigmoid function and is available at reference number 60 as output amplitude values AA.

The system for dynamics compression of the images or signal series may operate in an analog manner, in which case, for example, the local spatial averaging is implemented by electronic circuits having transconductance operational amplifiers which, in an approximated manner, equals a reduction of excessive differential amounts ABS (EA-<EA>). The special type of the local average value has a relatively minor influence on the result. In the case of images, the averaging area or range should be square or circular, with weights decreasing from the center. Deviating therefrom, the averaging range may also be rectangular or elliptical. As an alternative, the system can operate numerically by means of a digital circuit. In both analog and numerically simulated networks, an exponential drop occurs around the center of the averaging range as a result of feedback.

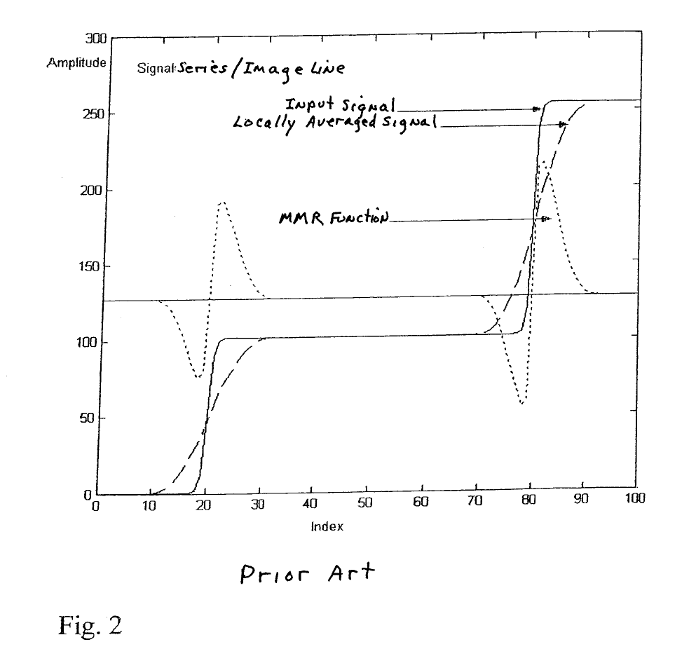

FIG. 2 illustrates dynamics compression of images or signal series according to the known Mead-Mahowald retina function (MMR function). For constant ranges (that is, ranges of a constant brightness) of the input amplitude values EA, the values of the MMR function are always at GA=0.5 (256), thus at half the maximal amplitude for 8-bit data. At the edges of the input signal (illustrated by a solid line in FIG. 2), the locally averaged signal (illustrated by a broken line) exhibits a corresponding deviation from the edge course. The difference between these two signals corresponds to EA-<EA>. After the application of a sigmoid function to this difference, the MMR function is obtained which is illustrated by a broken line. Since the difference EA-<EA> disappears in the ranges of constant input amplitude values EA, the half of a maximal amplitude GA previously mentioned is obtained here.

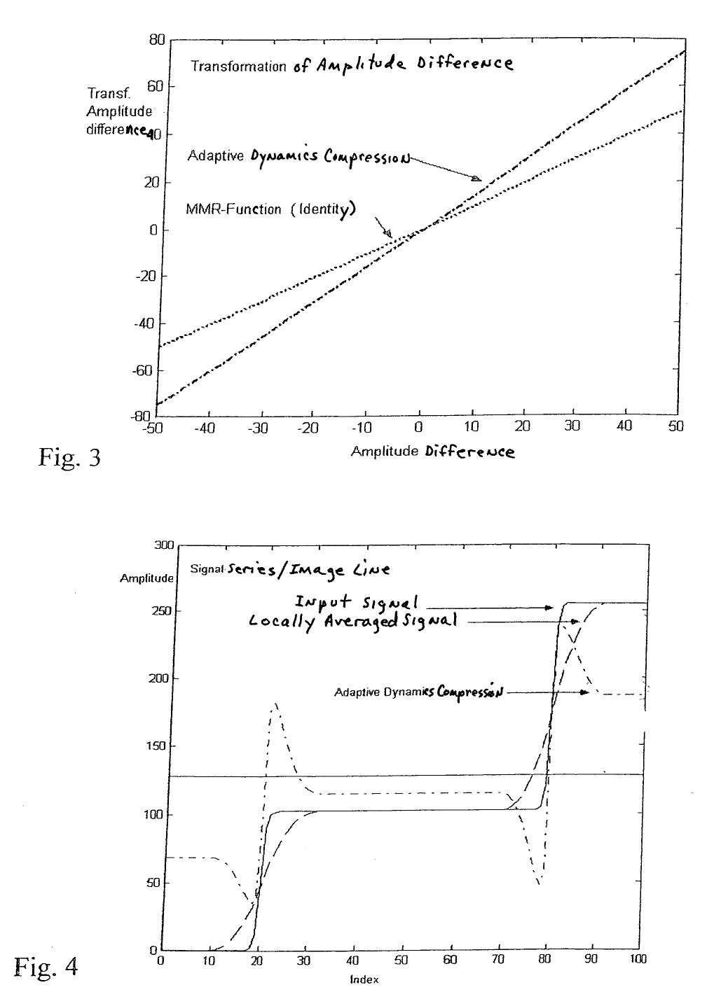

In contrast, FIG. 3 shows the dependence of the transformed amplitude difference EA-<EA> or EA-<EA>+b.(EA-GA) in the case of the conventional MMR function (dotted line) or according to the adaptive dynamics compression corresponding to the embodiment illustrated in FIG. 1.

As a result of the modification by the term b.(EA-GA), the completely different structure of the output signals AA illustrated in FIG. 4 is obtained. It is illustrated that originally bright or dark ranges of the input amplitude values EA (solid line) in the final result also lead to bright or dark ranges of the output amplitude values AA (dash-dotted line), however, when subjected to dynamics compression. This means that dark constant ranges with amplitude values <GA again become dark constant ranges, and bright constant ranges with amplitude values >GA again become bright constant ranges. It is only at the transitions (at the edges) that, because of the difference formation EA-<EA>, an additional stronger shaping of the edge structure becomes visible.

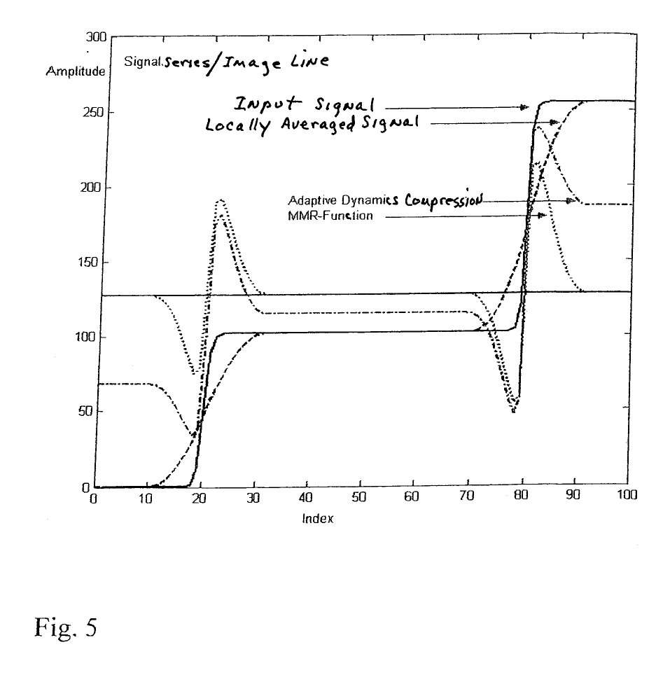

Again, for the purpose of a direct comparison, FIG. 5 shows the different course of the output amplitude values in the case of the conventional MMR function (dotted line) and of the output amplitude values which are obtained after a modified difference formation according to the described embodiment (dash-dotted line). In contrast to the state of the art, in the case of the local brightness transformation, the brightness order is therefore essentially maintained; that is, dark ranges remain dark and bright ranges remain bright; not all brightness values in homogeneous image segments are transformed to an average brightness.

In contrast to the known Mead-Mahowald retina function, a processing of multicolor images is therefore also possible. In a three-channel RGB display, for example, the application of the known MMR function does not lead anywhere because all ranges that are homogeneous with respect to color are also homogeneous in each of the three color channels; thus they automatically assume the average value GA, which then would result in median gray ranges in the color image. In contrast, as a result of the modified difference formation, as illustrated at reference number 40 in FIG. 1, in the case of a vectorial local spatial averaging with <EA>=(<EAR>+<EAG>+<EAB>)/3, in the modified difference EA-<EA>)+b.(EA-GA), the amplitude average value is not formed by way of the channels but vectorially, whereby the direction of the color vector, with the exception of influences by non-linearities, are maintained virtually unchanged.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-26. (canceled)

27. A process for dynamics compression in images or signal series which are represented by individual amplitude values, said process comprising:
performing local spatial amplitude averaging of input amplitude values EA of the images or signal series to generate locally spatially averaged input amplitude values <EA>;
forming differential function values based on differences between the input amplitude values EA and the locally spatially averaged input amplitude values <EA>; and
generating output amplitude values AA of the images or signal series, based on the formed differential function values;
wherein, in forming the differential function values, additional differential values are superimposed on said differences, which additional differential values are formed from the input amplitude values EA and a predefined reference value GA.

28. The process according to claim 27, wherein the output amplitude values AA of the images or signal series are generated by applying a sigmoid function to the formed differential function values.

29. The process according to claim 27, wherein the differential function values are formed according to the expression (EA-<EA>)+b.(EA-GA), wherein b is a predefined weighting factor.

30. The process according to claim 27, wherein the local spatial amplitude averaging is performed over an averaging area, with weights decreasing from the center of said averaging area.

31. The process according to claim 30, wherein the averaging area is one of square, circular, rectangular and elliptical.

32. The process according to claim 27, wherein the reference value GA has a constant value.

33. The process according to claim 32, wherein reference value GA is set to half of a maximal amplitude of the input amplitude values EA.

34. The process according to claim 27, wherein non-color images are processed.

35. The process according to claim 27, wherein color images are processed.

36. The process according to claim 35, wherein the formation of the differential function values is performed separately for respective color channels.

37. The process according to claim 34, wherein:
the differential function values are formed vectorially; and
a vectorial averaging of the input amplitude values EA is performed according to the expression <EA>=(<EAR>+<EAG>+<EAB>)/3.

38. The process according to claim 27, wherein the process is carried out in an analog mode.

39. The process according to claim 27, wherein the process is carried out digitally.

40. A system for dynamics compression in images or signal series which are represented by individual amplitude values, said system comprising:
means for locally averaging input amplitude values EA of the images or signal series to generate locally spatially averaged input amplitude values <EA>;
means for forming differential functional values based on differences between the input amplitude values EA and the locally spatially averaged input amplitude values <EA>; and
means for generating output amplitude values AA of the images or signal series based on the formed differential function values;
wherein the system further comprises means operable when the differential function values are formed for superimposing additional differential values on said differences which additional differential values are formed from the input amplitude values EA and a predefined reference value GA.

41. The system according to claim 40, wherein the output amplitude values AA of the images or signal series are generated by applying a sigmoid function to the formed differential function values.

42. The system according to claim 40, wherein the differential value is generated according to the expression (EA-<EA>)+b.(EA-GA); and
b is a predefined weighting factor.

43. The system according to claim 40, wherein the local spatial amplitude averaging is performed over an averaging area, with weights decreasing from the center of said averaging area.

44. The system according to claim 43, wherein the averaging area is one of square, circular, rectangular and elliptical.

45. The system according to claim 40, wherein the reference value GA has a constant value.

46. The system according to claim 45, wherein the reference value GA is set to half of a maximal amplitude of the input amplitude values EA.

47. The system according to claim 40, wherein the system processes non-color images.

48. The system according to claim 40, wherein the system processes color images.

49. The system according to claim 48, wherein the formation of differential function values is performed for respective color channels.

50. The system according to claim 48, wherein the differential function values are formed vectorially; and
a vectorial averaging of the input amplitude values EA is performed according to the expression <EA>=(<EAR>+<EAG>+<EAB>)/3.

51. The system according to claim 40, wherein the system operates in an analog manner.

52. The system according to claim 40, wherein the system operates digitally.
